(19) United States
(12) Patent Application Publication
(10) Pub. No.: US 2004/0205821 A1
(43) Pub. Date: Oct. 14, 2004

(54) Tv rf switching system

(76) Inventors: Eugene Yamada, Layton, UT (US); Edward Travis, Park City, UT (US); Glen Oakeson, Fillmore, UT (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/487,847

(22) PCT Filed: Aug. 13, 2002
(86) PCT No.: PCT/US02/25742

Related U.S. Application Data
(63) Continuation-in-part of application No. 10/217,950, filed on Aug. 12, 2002, now abandoned.
(60) Provisional application No. 60/312,093, filed on Aug. 13, 2001.

(51) Int. Cl. H04N 7/173; H04N 7/16; H04N 7/18; H04N 7/00; H04N 11/00

(52) U.S. Cl. 725/80; 348/552; 725/133; 725/141; 725/153

(57) ABSTRACT

A TV signal switching system (10) including a switch (12) configured to be connected to two or more signal sources such as a DVD player, VCR, satellite receiver, cable TV connection, VHF/UHF antenna, computer, Web TV and other internet interfaces, TiVo and other digital recording and playback systems, game console, a live feed from a video camera or other image capture device, or other TV signal source, and connectable to a remote TV monitor (28) by a coaxial cable (22) or equivalent, and a switch controller (34) located adjacent the remote TV configured to select a signal source for the remote TV monitor by signaling the switch over the coaxial cable to connect the desired signal source (14 16 18, or 20) to the remote TV monitor.

### BACKGROUND

The invention relates to TV signal switching Systems. More particularly, the invention relates to remote TV signal switching wherein the signal source switch is not immediately adjacent to or visible from the remote TV monitor.

In providing TV systems where one or more than one TV monitors will be connectable to more than one signal source, and where the means to switch between signal sources is remote from at least one of the TV monitors, it has been problematic to provide switching between signal sources. Particularly where the switch is in another room, or not otherwise immediately available to a user at a particular monitor, switching between signal sources can be inconvenient, for example requiring the user to go into the other room to change the signal source. Conventional remotes using infrared signaling do not work well where the receiving apparatus is out of sight or too far away. One solution is to provide a low power RF transmitter in the remote and a RF receiver at the source switching apparatus. For example satellite receivers located in one part of a house which are connected to a plurality of monitors, one of which is remote, have been provided with RF receivers which allows a low-power RF remote control in a room in another part of the house adjacent a remote TV monitor to signal the receiver to change the channel and/or satellite signal source.

However, where it is desired to provide a remote switching capability between multiple signal sources such as independent devices, e.g. VCRs, DVD players, local TV antennas, satellite receivers, cable connections, computers, game consoles, live camera feeds, etc., usually a switch apparatus is required. Moreover, when such a device is provided a user goes to the switcher box connecting a plurality of sources to a plurality of TV monitors, and selects which source will feed which TV monitor. This can be inconvenient, as it can necessitate a user going to another room or part of the dwelling or vehicle as mentioned. And further mechanical switching means can have the inherent problems of noise and cross talk.

Moreover, it will be appreciated that in addition to household and enterprise/facility systems where a home or building structure is involved, systems using multiple signal sources and more than one monitor are common on vehicles, such as RVs, yachts, aircraft, etc. In these applications, low power consumption can be important, and it can be desirable to have the system be hard wired, that is to say, the switching system signals be carried by wires rather than broadcast. Further, in the latter case additional wiring besides the coaxial cable connecting the various TV monitors is inconvenient to install, and in the case of retrofitting a system, it is very difficult, or can result in unsightly wires running in places where they can be visible.

### SUMMARY

It has been recognized by the inventors that it would be convenient to have the capability to provide TV signal source switching which uses the coaxial cable bringing the TV signal to the monitor to convey switching command signals to a switch at a source location. It has also been recognized that to do so without providing a detectable degradation in picture quality on TV monitors connected to the system, even on a transient basis, is also desirable. It has been recognized that it would be desirable to provide a system with very low power consumption requirements, particularly in a vehicle application using a battery power source.

The invention is directed to these ends, and provides (a) a switch apparatus coupleable to a plurality of video signal sources, and to at least one TV monitor via a conventional coaxial or twin lead signal cable; (b)a source selector control configured to be placed adjacent the monitor and connectable to the signal cable whereby a video signal is delivered to the monitor from the switch apparatus; whereby the signal source for the TV monitor can be selected for presentation on the monitor from the plurality of signal sources by user selection at the remote monitor using the source selector located at the monitor and the source selector communicates with the switch via the cable connecting the TV monitor to the switch apparatus, said cable also bringing the RF TV signal to the TV monitor for viewing.

The system can be configured so that the switching means uses a low frequency and/or digital signal and filtering so that the signal source selector signaling the switch apparatus does not cause interference with the video signal on viewable on the one or more TV monitors connected to the switching apparatus.

The switching apparatus can be connected to video signal sources such as Broadcast TV from an antenna, Satellite receiver(s), DVD players, VCRs, a cable connection, live feed(s) from video cameras or other video image capture device(s), computer(s), game consoles, Web TV and other internet interfaces, TiVo and other digital video delay and playback apparatus, and the like. And at one or more viewer's locations, each of one or a plurality of connected signal source selectors and associated TV monitors can be connected to the switch via a coaxial cable. The coaxial cable carries both the TV signal to the particular remote TV monitor, and the switcher control signals back from that location to provide for user selection of signal source for that location independent of user selection of signal source at any other remote location.

The signal source selector system can further comprise a data transfer interface, whereby signal source selection for one or more monitors can be made through a computing device connectable to the system. Said interface can be a serial, USB, firewire, or other data bus type. Moreover, such an interface can enable control of signal source selection at one or all monitors from a central location. It can also enable expansion of the system by connecting additional switching capability via the data interface.

Further features and advantages will be apparent to those skilled in the art with reference to the following detailed description of exemplary embodiments, which illustrate one or more specific implementations of the invention, by way of example.

### BRIEF DESCRIPTION OF THE DRAWING FIGURES

FIG. 1 is a functional block diagram of a switching circuit for a switch in one embodiment of the invention, configured for use in an recreational vehicle (RV), with four inputs independently selectable for output to 3 outputs (comprising 3 TV monitors or a combination of one or more recording devices and TV monitors);

FIG. 2 is a block schematic diagram illustrating use of the switch of FIG. 1 with exemplary signal sources and TV monitors;

FIG. 3 is a functional block diagram of a switch controller and front panel of same for use with the switch of FIGS. 1 and 2;

FIG. 4 is a schematic diagram of the controller of FIG. 3 showing further detail;

FIG. 5 is a functional block schematic diagram of the system of FIG. 1, showing further detail regarding connections, cross referenced with FIG. 6;

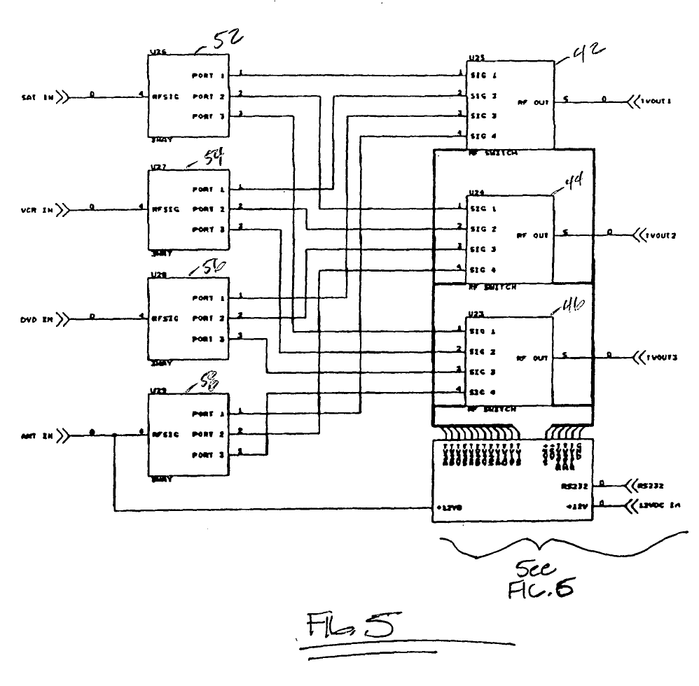

FIG. 6 is a schematic block diagram of the switch of the system of FIG. 1, showing connections to switch microprocessor (controller), serial data bus, power, signal inputs and outputs, etc. cross referenced with FIG. 5;

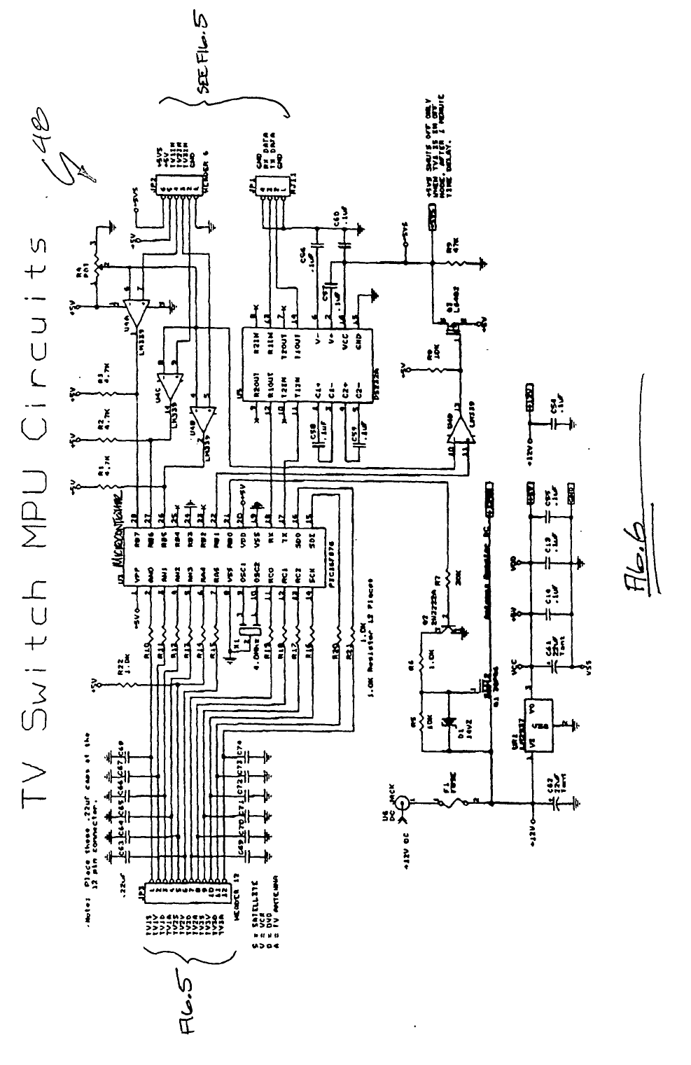

FIG. 7 is a schematic diagram of a power divider circuit for the system of FIG. 1 for each of the outputs;

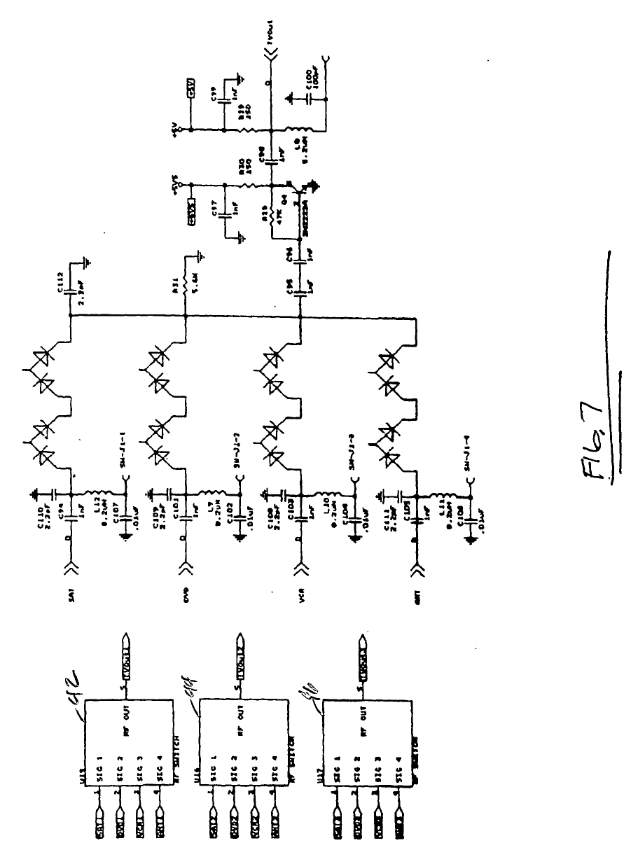

FIG. 8 is a schematic diagram of a power divider circuit for the system of FIG. 1 for each of the signal inputs;

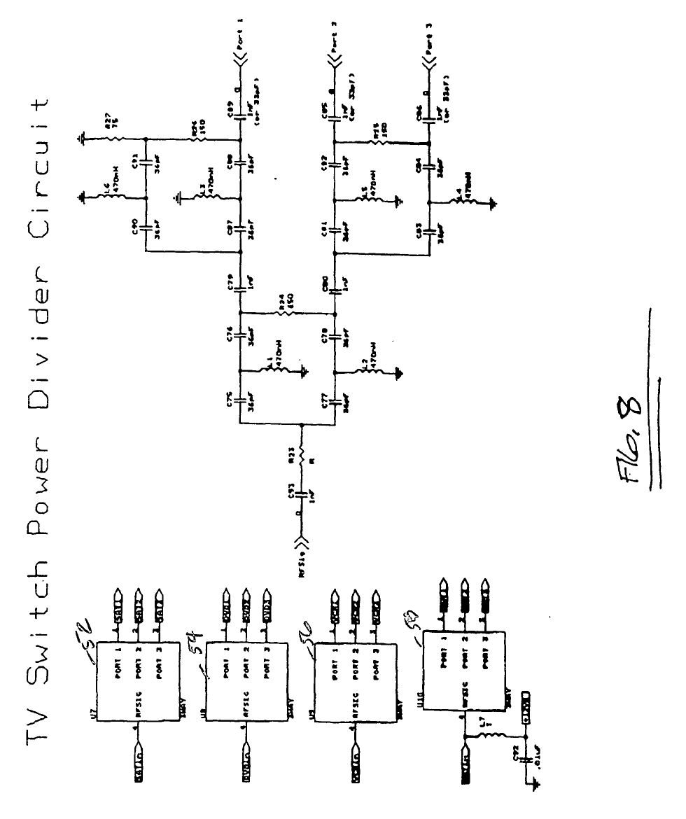

FIG. 9 is a schematic diagram of another embodiment of the power divider circuitry shown in FIG. 7;

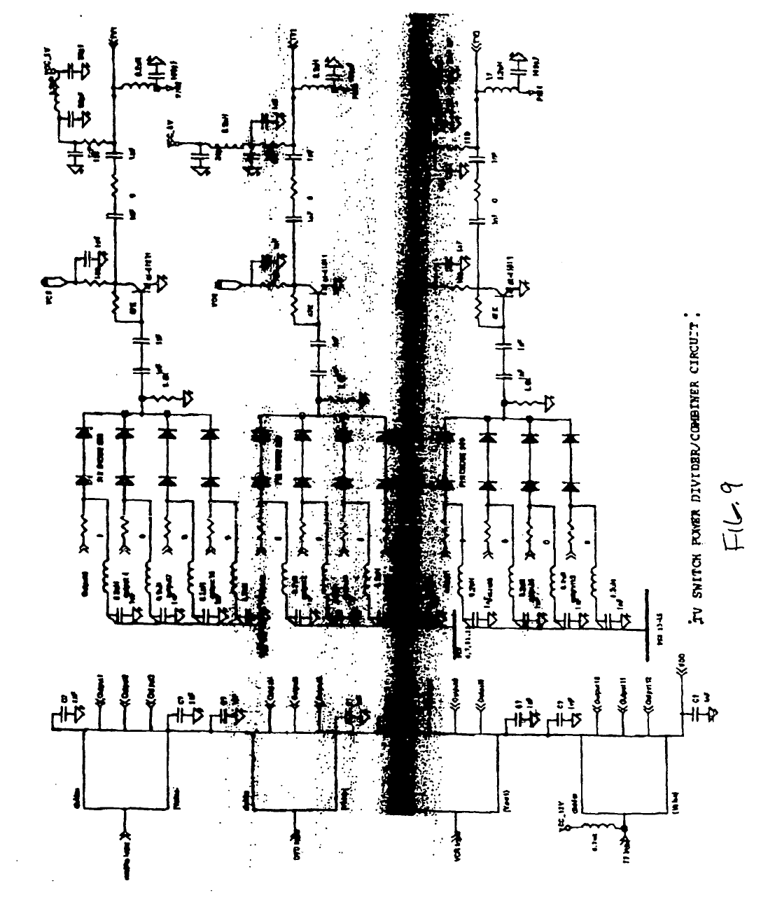

FIG. 10 is a schematic diagram of another embodiment of the power divider circuitry shown in FIG. 8;

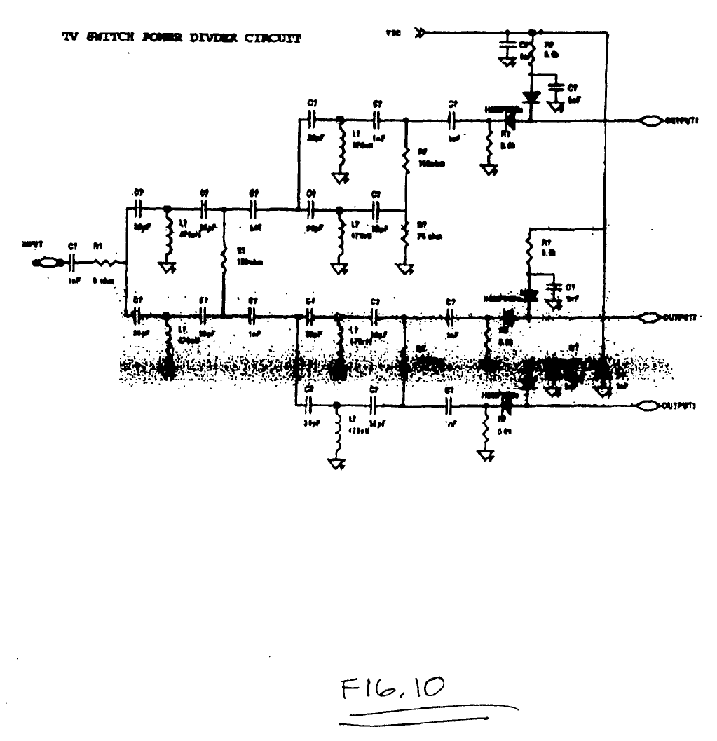

FIG. 11 is a schematic diagram illustrating another embodiment of the switch circuitry shown in FIG. 6;

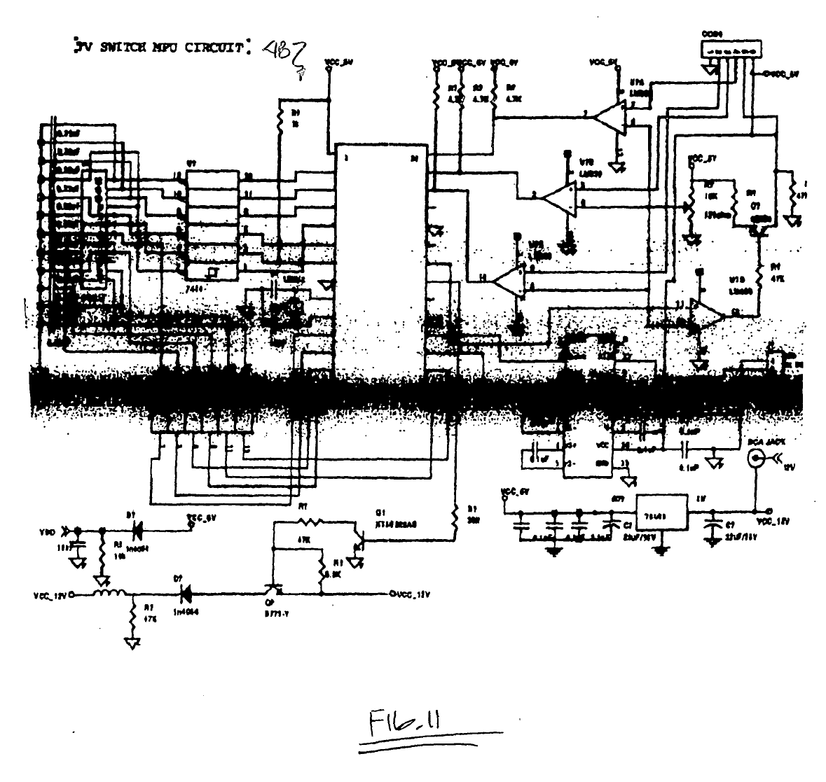

FIG. 12 is a schematic diagram illustrating another embodiment of the switch circuitry shown in FIGS. 6 and 11, including additional buffers, power and RF signal cut off switch, and polyfuse, but not showing the data bus connection (RS232 in prior FIGS. );

FIG. 13 is a schematic diagram of the illustrating another embodiment of the power divider circuitry shown in FIGS. 8 and 10;

FIG. 14 is a schematic diagram of the illustrating another embodiment of the power divider/combiner circuitry shown in FIGS. 7 and 9; and

FIG. 15 is a schematic diagram illustrating another embodiment of the switch controller of FIGS. 3 and 4.

### DETAILED DESCRIPTION OF EXAMPLE EMBODIMENTS

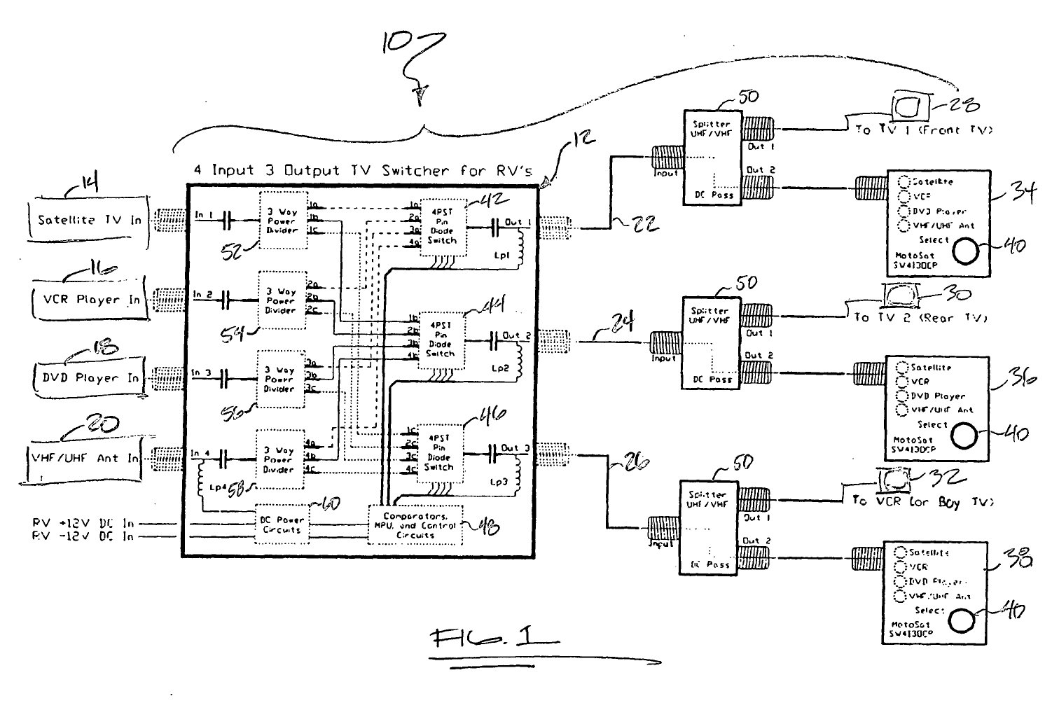

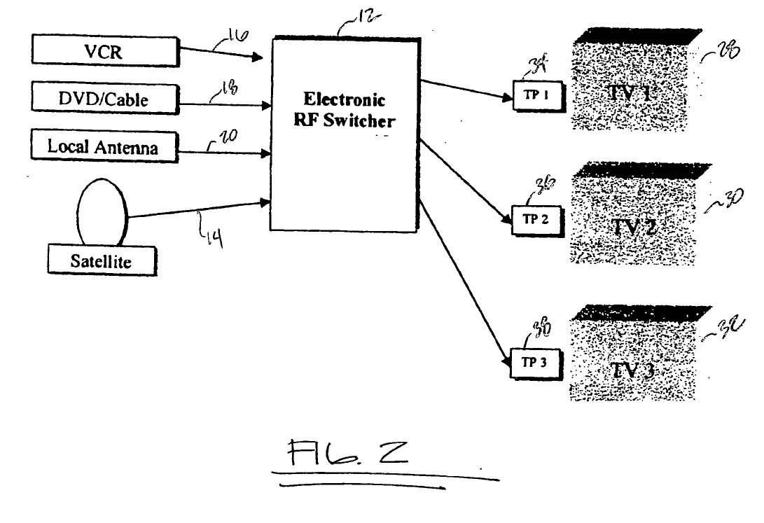

With reference to FIGS. 1 and 2 of the enclosed drawing figures schematically illustrating exemplary embodiments of the invention, which are given by way of example and not by way of limitation as well as the example description of operation in a recreational vehicle (RV) setting, the system 10 includes a switch unit 12 connected to a plurality of input sources 14, 16, 18, 20. The switch is connected by coaxial cables 22, 24, 26 to one or more (here, three) TV monitors 28, 30, 32, which can be at a remote location. For example, in an RV setting there can be a front and back TV set and one additional TV set, in the illustrated embodiment this can be located at the location of the VCR signal source. As will be appreciated additional signal sources and monitors can be added by repetition of the elements shown. There is a switching panel (or in other words a switch control unit) 34, 36, 38 associated with each television monitor in the illustrated system incorporating a plurality of such TV sets.

These panels 34, 36, 38 “sleep” until a user depresses the selection button 40, which switches the signal source, at which time a panel “wakes up” and sends a signal to the central switching unit 12 where switching takes place by means of diode switches 42, 44, 46 controlled as shown by microprocessor and control circuitry 48. This sleep feature has particular advantages in an application in an RV where power use is an issue. However, it is also advantageous in home applications because the power for the panels is carried by the coaxial cable which also carries the signal to the monitor and in sleep mode the system draws very little power at the switching panels. The control panel units 34, 36, 38 are parallel connected to the coaxial cables 22, 24,26 by splitters 50 located adjacent the monitors 28, 30, 32.

In the exemplary embodiment, each of three monitor 28, 30, 32 outputs can be individually independently connected to one of four inputs 14, 16, 18, 20 comprising for example different TV signal sources. However, there is no particular limitation to the number of inputs or output, and additional inputs, as well as additional outputs could be incorporated in the system as mentioned. Power dividing/combining circuits 52, 54, 56, 58, shown more fully in other FIGS. route signals (power, digital switch control, and TV(RF)) and cooperate with the diode switches 42, 44, 46 to provide switching and limit noise and cross talk. DC power supply circuitry 60 provides power to the system 10, and to an external amplifier (not shown) on the UHF/VHF antenna 20 line.

Moreover, while a satellite signal source 14 and other signal sources such as DVD 18 and VCR 16, VHF/UHF antenna 20, as shown, are contemplated other signal sources can be added or substituted. For example, a live signal feed from a video capture device can comprise one input, or a computer video output, or an Internet connection device, such as web TV, or a video game console, TV, or other device, as mentioned above. As mentioned, in connection with the VHF/UHF antenna signal source 20, the signal can have an amplifier externally, or it can be incorporated in the central unit, to enable a boost mode for better reception at the monitor when that signal source is selected.

Furthermore, in addition to varying the number of inputs and outputs, because of the data bus capability (e.g. a RS232 interface incorporated in the system), two or more units 10 can be daisy-chained to allow for additional inputs and outputs. For example, daisy-chaining two units would allow 8 inputs and 6 connected monitors, using two systems as in the illustrated example. As will be apparent, additional switching units would have to be connected to allow selection of additional sources over the four illustrated.

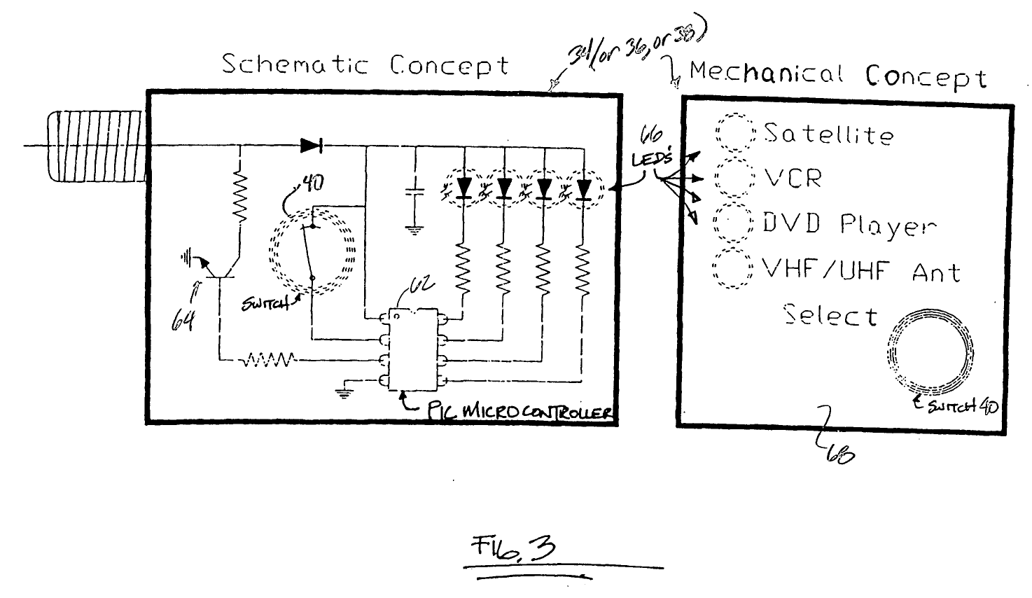

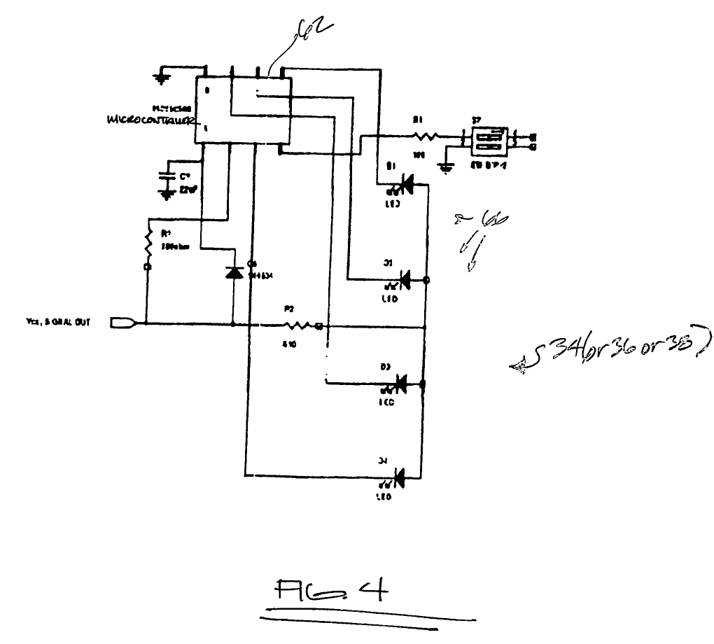

It will be appreciated with reference also to FIGS. 3 and 4 of the appended drawings that the switch panel 34, 36, 38 associated with each monitor 28, 30, 32 will send a signal to the central unit 12, where a diode switch 42,44,46 will perform the actual selection of signal source. Once the source has been switched, then the panel at the TV monitor location can return to sleep mode and until another section is made, and the signal source for that monitor will continue to be the previously selected source. The controller includes a microprocessor 62 and transistor 64 cooperating to send control data (pulses) to the central unit 12. LEDs provide an indication of selected signal source to the front of the control panel 68 viewable and used by the user to select the signal source for the associated TV monitor 28 (or 30 or 32).

At the switching panel 34, 36 or 38) associated with each monitor 28, 30, or 32, a PIC microcontroller 62 is included which is programmed to carry out the functions just described, upon moving the selection switch 40 to a new signal source, and after appropriate amount of time returns to sleep mode until the signal selection switch is moved again. This microcontroller cooperates with a microcontroller circuitry 48 at the central unit 12 to control the diode switches 42,44,46 as will be appreciated.

In another embodiment (not shown), the panel can be programmed and appropriate controls included to enable directing a VCR to begin recording from another source such as the satellite TV or antenna source by incorporation of further diode switches and software both at the central switch block, and the panel switch switching unit associated with a particular monitor. As will be appreciated, an interface unit at the VCR (not shown) can be provided to switch the unit on and initiate recording. Furthermore, given that there is an RS232 interface, additional control capability may be added. For example, the system could be controlled through a connected computer or other RS-232 or other data bus compatible device. This allows additional functionality as logic can be added, control functions improved, by means of a connected device with appropriate software loaded.

For example, one enhanced control function would be to enable interruption of the TV signal from one or more of the signal sources to each and all monitors with a signal from another source upon occurrence of a triggering event. As an example, one signal source might be a live camera, such as a CCD or CID image capture device, coupled with a motion detector. Upon detecting motion near the camera the signal source can be switched by the software to the remote camera signal source for some period of time. This would enable, for example, a camera and motion sensor to be placed near the door of a home or RV, and when a person approached the door, the signal to one or more, or all, monitors could be interrupted and an image of the person approaching the door could be displayed for a limited period of time, say 5 seconds.

In another embodiment of this same technology, the signal sources might all be cameras in a security system monitored by a security guard, and from various remote monitors throughout a building where the system is installed, the security guard can select a signal source, and therefore see what is happening at a remote camera location from any one of a number of monitors scattered throughout the physical plant. Moreover, combined with a motion sensor, the device could be configured so that the signal is automatically switched to any area where motion is detected. The display at any one or more monitors can thereafter be returned to its normal view, or can remain switched to the signal source where motion is detected as long as motion continues to be detected at that location.

Furthermore, one of the monitors could be a video signal recording signal device, and in addition to monitoring by a live person, the signal source could be switched to any of the various inputs comprising remote cameras when motion is detected and the recording device be activated to record what is occurring at the location where motion is detected. This will enable an automatic security system to selectively monitor areas where motion is detected.

As will be appreciated, all the forgoing and following functionalities described can be implemented with cabling already installed in a video display system previously used. For example, in a system where, formerly, all monitors (or by means of a mechanical selector one of a number of monitors) could receive a signal, all controlled from a central location, the invention enables control from any monitor location without installing additional cabling. This can be a significant cost savings. In home and RV applications, where the coaxial wiring is already in place, a retro-fit is straightforward, and in new construction costs are lower too, as in both cases additional cabling is not needed, reducing labor and materials cost. In retro-fit applications particularly labor costs are reduced for this reason.

Returning to operation of the system, video sources, as well as video outputs can be switched on and off through the RS232 or other data bus interface. This will enable further control of the system from a remote source.

In another embodiment, the switching unit at the monitor may be configured to be compatible with a conventional TV remote, for example incorporating a infra red or RF wireless link, and this will enable signal source selection, as well as volume control and other functions from a viewer seated at a viewing distance rather than requiring the viewer to manually access the control panel.

Furthermore, by means of the RS343 interface, a control system for the home, or RV can be connected with the TV switching system so that the display can be interrupted with a status report or warning regarding some detected problem, such as an out-of-norm parameter. For example, if an onboard control system of an RV detects a imminent low battery power or low fuel condition, a warning may be flashed through the video switching system to be viewable at a monitor. In a home application, as an example, if a home security system detects a break-in or a system failure, a warning can be sent so as to be viewable at a monitor.

In another more detailed aspect, additional signal sources can be incorporated or used in the system, for example, an Internet connection signal, or a video game video output, can be directed to the monitor. As currently contemplated, the other interface elements, such as keyboard mouse, game controllers, etc. will have a separate connection through wireless or other means to a computer, game console, wireless Internet device, etc., as may be applicable, but as will be apparent, using the functionality of this system, a further capability, not currently shown, but possible, is communication with a device comprising a signal source through the system using the cable conveying the video signal to the monitor, as well as the switching signals from the switching panel positioned adjacent the monitor. In this regard, appropriate switching can be accomplished to enable the control signal to be fed back through the coaxial cable or other cabling provided in the system to the signal source to be controlled via another remote unit adjacent the signal source, or through the RS232 interface. This would enable control of the signal source, such as an Internet connected device, or a game console, for example, through the coaxial cable to the remote location where the TV monitor and the user are located.

Moreover, additional modifications and alternative embodiments will be apparent to those skilled in the art, for example, the particular interface could be, instead of a RS232, a USB port, FireWire port, etc. Moreover, while the invention has been discussed primarily in terms of home and recreational vehicle installations, as will be apparent, it could comprise a video system in a commercial setting, such as facilitating video conferencing across a plant or an enterprise, from city to city or world wide, with a central switching unit and remote switching panels located at each plant or other site where the system is incorporated; and users in individual locations such as conference rooms or offices are able to select from that location a particular signal source to receive there. Therefore, in addition to the security applications mentioned above, the audio-visual capabilities of a building, plant, etc. can be enhanced with application of the invention.

Particularly with respect to the RV, houseboat, yacht, aircraft, and other applications where the low power requirements and ability of the system to “sleep” and draw de-minimus power until a user activates it are important, the system can allow prolonged periods where it is not turned off completely without draining batteries or otherwise compromising the electrical system of the vehicle/craft. Further, the system is advantageous in that it can be installed aftermarket where coax was included to wire for TV, as only the coax is needed for the switchbox controllers at the various monitors to communicate with the switch, and no additional wires need to be run.

Moreover, another advantage is that there are no “mechanical” switches, so the inherent noise and cross-talk of those devices are avoided. The signaling for switching occurs below the RF signals to the various monitors, and is filtered out so that switching signals do not cause noticeable interference with the RF TV signal.

In the illustrated embodiments 4 inputs can be selectively independently directed to one or more of 3 outputs (each comprising a switch controller box and TV monitor). In an example implementation in a houseboat or RV, one person at a front end can be watching TV from a satellite receiver, while another is watching a movie from a DVD player, while a VCR is recording a program from local broadcast television (UHF/VHF). The switch unit is placed where the 4 inputs (say DVD player, VCR, UHF/VHF, satellite receiver, but one or more of these can be instead a computer, game console, TiVo, Web TV, live video camera or other image capture device feed, etc.) and 3 outputs (say coax cables) can be accessed. As an aside, the number of inputs and outputs can be different, by adding or subtracting relevant circuit elements such as those shown and described herein. The switch control boxes are located at the coaxial cable terminus at each TV monitor. The controllers will each display the selected input for that TV. To select another input, the user simply presses the select button until the desired source is indicated by the LED indicator light on the panel. Successive actuations of the button toggles through the four available inputs sequentially and repeats.

In one embodiment one or more recording devices could also be located at one or more TV monitors. That is to say, the output at a TV monitor can be recorded, so for example in addition to the VCR as a source, a VCR at a TV monitor, or connected to the output to a TV monitor can record the signal selected for that particular monitor.

The Switching unit 12 has four independent inputs through F-type connectors. These inputs are 75 ohm impedance. The input frequency is 40 to 600 MHZ. Each input is AC coupled and goes to a 75 ohm 3-way power divider. Each power divider output goes to a four pole single throw pin diode switch circuit which can have a port to port isolation of 25 dbm minimum up to 100 MHz and 18 dbm to 500 MHZ. The output ports of the 4 power dividers are connected to the 3 pin diode switch circuits. Each switch circuit is independently controlled from the microprocessor and control circuitry of the switch unit. Each switch circuit only allows one input to pass through. The output of each 4PST pin diode is AC coupled.

A small DC voltage, approximately 8 volts, with a maximum current capability of 15 ma is connected to the outputs of the switch unit via low pass chokes (LP1-LP4) as shown in the FIGS. This voltage travels through the coax cables and supplies power to the switch controller panels at each of the TV monitors.

At the control panels, a momentary SPST switch is provided, which when held down will cause the switch (and associated indicator LED's) to step through the 4 possible input selections sequentially (e.g. satellite, VCR, DVD player, VHF/UHF antenna). As long as the switch is depressed the panel will continue to cycle. The user can also press and release to step through the inputs. After release of the switch button, the MPU at the controller panel will delay for a short period, say one second, and then send a string of pulses that corresponds to the selected input (and LED indicator showing) to the transistor circuit which will cause the input supply voltage to pulse 1.5 to 2 volts below the nominal input voltage. These pulses are detected by the switch unit through the Lp1, and the comparator circuitry will convert the pulses to readable data on the switch unit microprocessor. The microprocessor win then control switching of the input to that TV monitor by sending the corresponding switch selection data to the 4PST pin diode switch circuit.

Lp4 allows for +12 volts to be switched to input 4 (UHF/VHF antenna in) when any of the control panels select this input. This voltage is use to power an external amplifier on the VHF/UHF antenna customarily provided on recreational vehicles. If no switch controller panels have this input selected, then no twelve volt supply voltage for the amplifier will be switched to this port.

The current is limited to 8 volt outputs that are connected to Lp1 through Lp3 inductors that are connected through independent voltage sensing resistors to allow the comparators to detect the data pulses form the controller panels at the TV monitors.

The pin diodes could instead be FETs if desired.

The size of the control panels can be quite small, as will be appreciated when it is considered that only a source indication (requisite number of LEDs, or other indicator) and a selection button are required. The microcontroller and circuitry will be physically smaller than the panel in most applications.

The switch microprocessor can have 12 output pins to control the pin diode switches. It can use 3 input pins to read the control panel pulses, and one output pin to enable the 12 volt supply voltage for the VHF/UHF port. This totals 16 I/O lines in one embodiment. Note that in one embodiment the MPU does not need EEPROM memory. If 12 volt vehicle power is interrupted, then all of the output ports can default to the output 1 position (say satellite). Then if a controller at a TV monitor is connected, it will send its last known switch condition approximately 5 seconds after vehicle power is restored.

In one embodiment the VHF/UHF input can be a cable input instead. Further in another embodiment the input can be configured to be externally swtichable between an antenna and a cable RF relay in at the input. In another embodiment a 5^{th}, 6^{th} or more additional inputs can be added, accommodating a cable input, live camera feed (say a security camera outside the vehicle) or other signal source as mentioned above).

The microprocessor in the control panel unit at each output (TV monitor) can be an 8 pin TinyAVR 8-bit MCU (Atmel ATiny121 Series 8 pin SOIC). This MPU can operate from an internal oscillator allowing up to 6 I/O lines. Four lines can directly drive indicator LEDs, one line can detect the SPST button position, and one line can activate the transistor pulse circuit. Typical operating current to this MPU can be less than 3 ma. Internal EEPROM can keep the current input selection stored during power loss in the vehicle or during extended storage where it is powered down.

The diode in the controller prevents the MPU voltage from dropping below 5 volts when the transistor circuit sends data pulses along the coax to the switch unit. The capacitor on the cathode side of the diode should be a 22 to 47 uf Tantalum to prevent the ripple from the transistor data pulse current. A zener diode or transistor can also be used in another embodiment.

The indicator LEDs can be a low current type using less than 3 ma when illuminated, and only one LED is active at any time. Moreover the transistor curcuit can be configure to drawn no more than about 10 ma when sending data pulses. The transistor can be configured to be in an off condition when data pulses are not being sent.

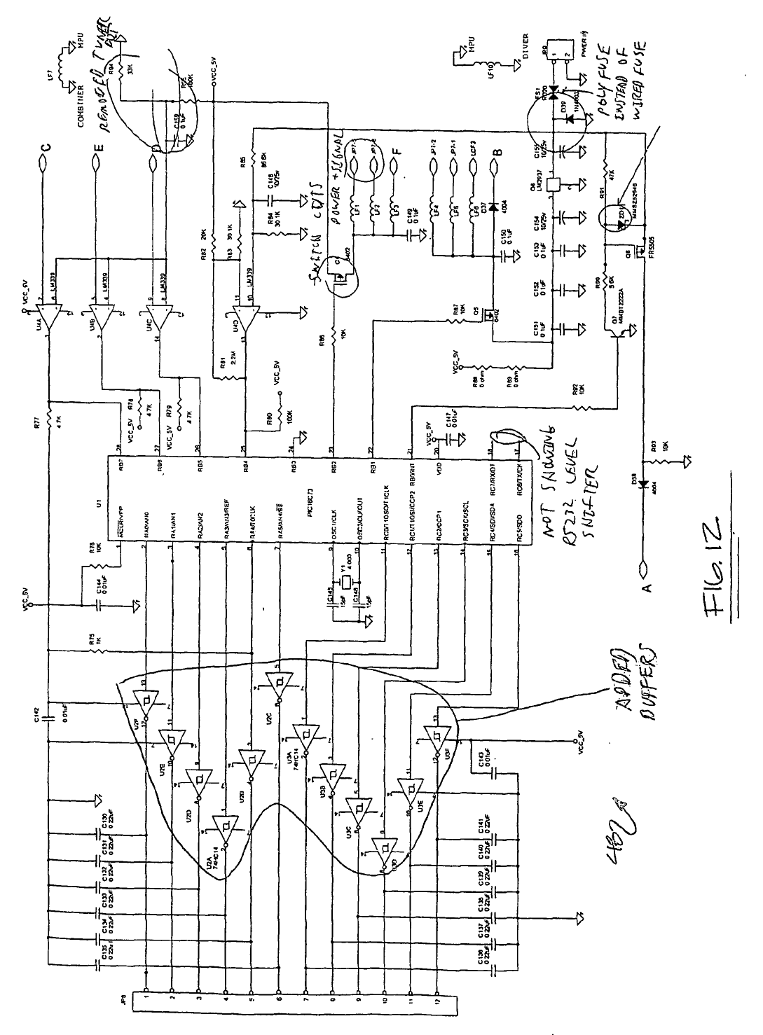

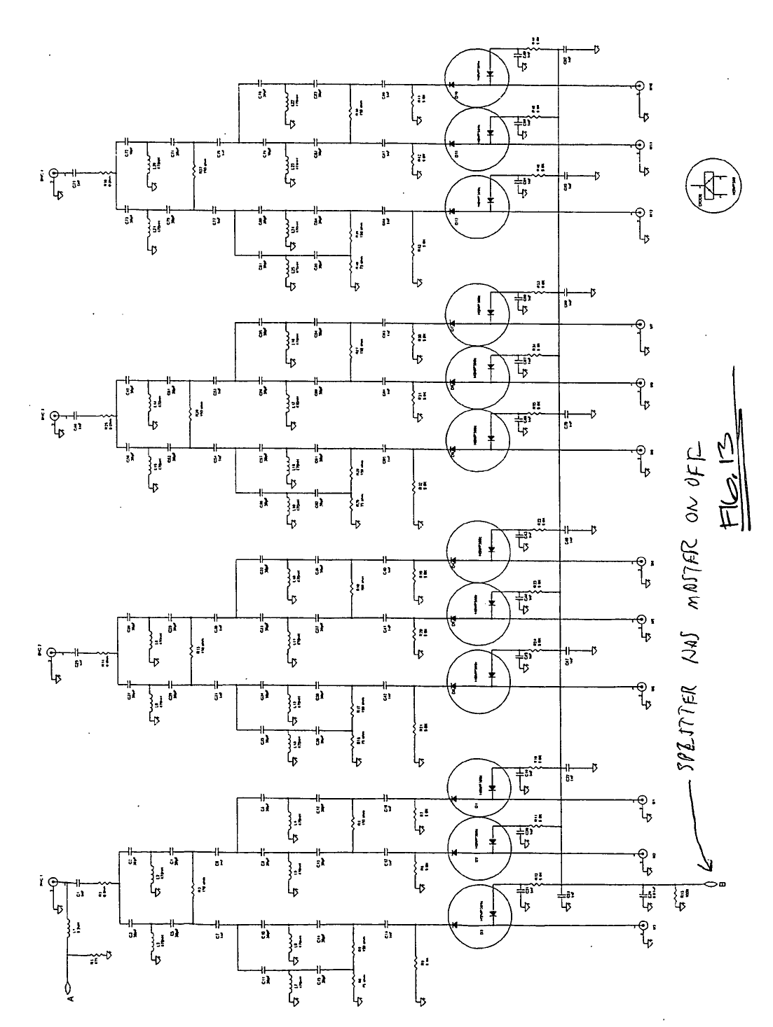

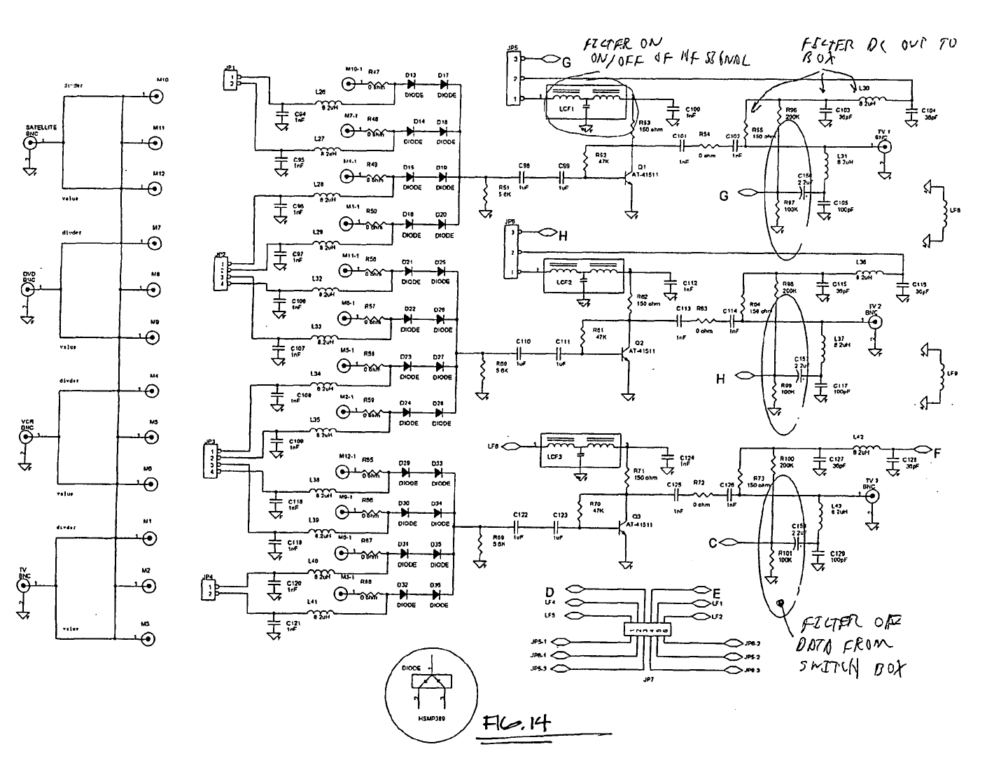

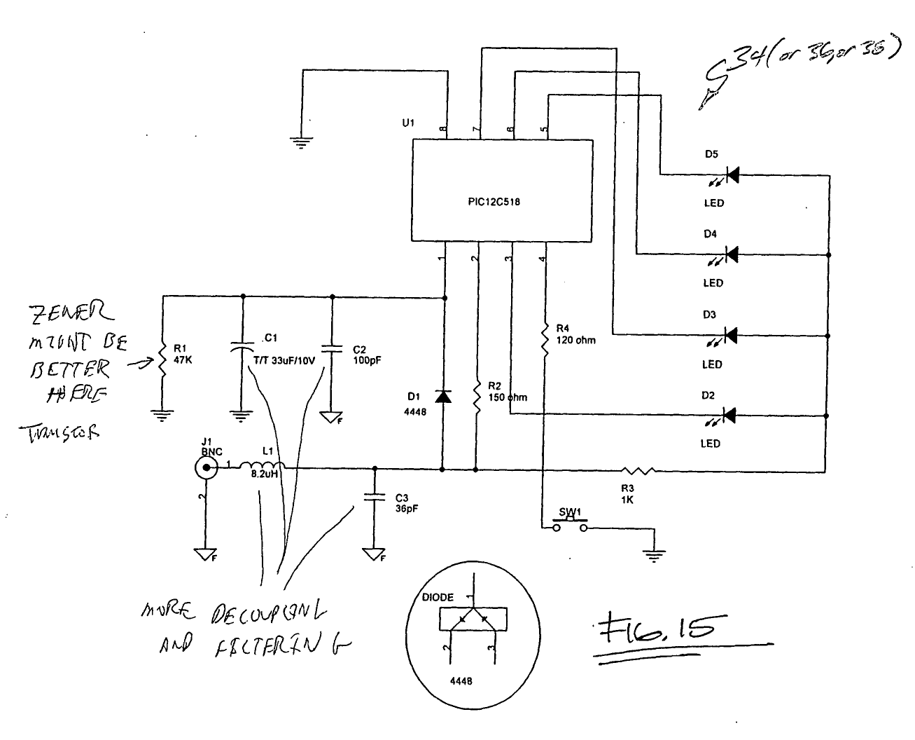

With reference to FIGS. 12-15 it will be appreciated that in one embodiment additional filtering and decoupling of the pulse signals, power signals, is provided. Moreover, a sleep mode is enabled where outputs are turned off when not in use, minimizing power consumption.

While particular implementations of the invention have been illustrated and described, other features and modifications will be apparent to those skilled in the art which are within the spirit and scope of the invention. The invention is not to be construed as limited to the particular examples given herein. Other alternatives are possible, and will be apparent to one skilled in the art after receiving the benefit of the teachings of this disclosure.

1. A RF signal switch system, comprising:
a switch apparatus coupleable to a plurality of video signal sources, and to at least one TV monitor via a conventional coaxial or twin lead signal cable;
a source selector switch controller configured to be placed adjacent the monitor and connectable to the signal cable whereby a video signal is delivered to the monitor from the switch apparatus; whereby the signal source for the TV monitor can be selected for presentation on the monitor from the plurality of signal sources by user selection using the source selector located at the monitor and the source selector communicates with the switch via the cable connecting the TV monitor the switch apparatus.

2. A system as in claim 1, wherein the switching means uses a low frequency signal and filtering so that the signal source selector signaling the switch apparatus does not cause interference with the video signal on viewable on the one or more TV monitors connect4ed tot the switching apparatus.

3. A system as in claim 1, wherein the switching apparatus can be connected to a plurality of video signal sources including one of a Broadcast TV signal from an antenna, a cable TV connection, a satellite receiver, a DVD player, a VCR, a live feed(s) from video camera or other video image capture device, a computer, a video game console, a Web TV signal, a digital video delay and playback apparatus.

4. A system as in claim 1, further comprising a data transfer interface, whereby signal source selection for one or more monitors can be made through a computing device connectable to the system.

5. The system of claim 4 wherein said interface can be one of a serial, USB, firewire, or parallel data bus type.

6. The system of claim 5 wherein said interface can enable control of signal source selection at one or all monitors from a central location.

7. The system of claim 6, configured to enable expansion of the system by connecting additional switching capability via the data interface.
